(19) United States
(12) Patent Application Publication
(10) Pub. No.: US 2022/0084249 A1
(43) Pub. Date: Mar. 17, 2022

(54) METHOD FOR INFORMATION PROCESSING, ELECTRONIC EQUIPMENT, AND STORAGE MEDIUM

(71) Applicant: Zhejiang SenseTime Technology Development Co., Ltd., Hangzhou (CN)

(72) Inventors: Danpeng CHEN, Hangzhou (CN); Nan WANG, Hangzhou (CN); Bangbang YANG, Hangzhou (CN); Guofeng ZHANG, Hangzhou (CN)

(21) Appl. No.: 17/536,730

(22) Filed: Nov. 29, 2021

Related U.S. Application Data
(63) Continuation of application No. PCT/CN2020/103890, filed on Jul. 23, 2020.

(30) Foreign Application Priority Data
Aug. 21, 2019 (CN) 201910775636.6

(51) Int. Cl. G06T 7/80; G06V 10/44; H04N 5/353

(52) U.S. Cl. CPC G06T 7/80; H04N 5/353; G06V 10/443

(57) ABSTRACT

Collecting time of collecting a first image frame to be processed is acquired. Calibrated time of the first image frame is acquired by correcting the collecting time of the first image frame according to currently calibrated time offset information for the first image frame. A current location is determined based on the first image frame and inertial sensor information acquired at the calibrated time of the first image frame.

### CROSS-REFERENCE TO RELATED APPLICATION

This application is a continuation of International Application No. PCT/CN2020/103890, filed on Jul. 23, 2020, which per se is based on, and claims benefit of priority to, Chinese Application No. 201910775636.6, filed on Aug. 21, 2019. The disclosures of International Application No. PCT/CN2020/103890 and Chinese Application No. 201910775636.6 are hereby incorporated by reference in their entireties.

### TECHNICAL FIELD

The present disclosure relates to the field of visual inertial navigation technology, and relates, but is not limited, to a method for information processing, electronic equipment, and a storage medium.

### BACKGROUND

Acquiring a six-degree-of-freedom spatial location of a camera in real time is a core basic issue in a field such as augmented reality, virtual reality, robotics, and autonomous driving. Multi-sensor fusion is an effective way to improve spatial positioning accuracy and algorithm robustness. Time offset calibration between sensors is the basis for multi-sensor fusion.

Most mobile equipment (such as a mobile phone, glasses, a tablet, etc.) have cheap cameras and sensors. There is a time offset between a camera and a sensor, and the time offset between the camera and the sensor is dynamically changing (such as every time the camera or the sensor is restarted, or with use time), therefore, this poses a great challenge to real-time positioning using both the camera and the sensor.

### SUMMARY

Embodiments of the present disclosure provide a method for information processing, electronic equipment, and a storage medium.

Embodiments of the present disclosure provide a method for information processing, including:

acquiring collecting time of collecting a first image frame to be processed;

acquiring calibrated time of the first image frame by correcting the collecting time of the first image frame according to currently calibrated time offset information for the first image frame; and

determining a current location based on the first image frame and inertial sensor information acquired at the calibrated time of the first image frame.

Embodiments of the present disclosure also provides a device for information processing, including:

an acquiring module configured to acquire collecting time of collecting a first image frame to be processed;

a correcting module configured to acquire calibrated time of the first image frame by correcting the collecting time of the first image frame according to currently calibrated time offset information for the first image frame; and

a positioning module is configured to determine a current location based on the first image frame and inertial sensor information acquired at the calibrated time of the first image frame.

Embodiments of the present disclosure provide electronic equipment, including:

a processor; and

a memory configured to store processor-executable instructions.

The processor is configured to implement the method for information processing herein.

Embodiments of the present disclosure provide a non-transitory computer-readable storage medium having stored thereon computer program instructions which, when executed by a processor, implement any method for information processing herein.

In embodiments of the present disclosure, collecting time of collecting a first image frame to be processed may be acquired; then, calibrated time of the first image frame may be acquired by correcting the collecting time of the first image frame according to currently calibrated time offset information for the first image frame. Given impact of a reason such as an error, there will be a certain time offset in the collecting time of the first image frame. Accordingly, the collecting time of the first image frame may be corrected to acquire a more accurate calibrated time. Then, a current location is determined in real time using the inertial sensor information acquired at the calibrated time and the first image frame, improving positioning accuracy.

It should be understood that the general description above and the elaboration below are exemplary and explanatory only, and do not limit the present disclosure.

Other characteristics and aspects of the present disclosure will become clear according to detailed description of exemplary embodiments made below with reference to the drawings.

### BRIEF DESCRIPTION OF THE DRAWINGS

Drawings here are incorporated in and constitute part of the specification, illustrate embodiments in accordance with the present disclosure, and together with the specification, serve to explain the principle of the present disclosure.

FIG. 1 is a flowchart of a method for information processing according to an embodiment of the present disclosure.

FIG. 2 is a flowchart of a process of determining time offset information of a first image frame according to an embodiment of the present disclosure.

FIG. 3 is a block diagram of acquiring a second image frame according to an embodiment of the present disclosure.

FIG. 4 is a flowchart of determining time offset information based on a second image frame and inertial sensor information according to an embodiment of the present disclosure.

FIG. 5 is a flowchart of determining an inertial state corresponding to each second image frame according to an embodiment of the present disclosure.

FIG. 6 is a block diagram of a time shift of an inertial sensor device and an image collecting device according to an embodiment of the present disclosure.

FIG. 7 is a flowchart of determining time offset information based on location information and an inertial state according to an embodiment of the present disclosure.

FIG. 8 is a flowchart of determining time offset information according to an embodiment of the present disclosure.

FIG. 9 is a block diagram of a device for information processing according to an embodiment of the present disclosure.

FIG. 10 is a block diagram of an example of electronic equipment according to an embodiment of the present disclosure.

### DETAILED DESCRIPTION

Exemplary embodiments, characteristics, and aspects of the present disclosure are elaborated below with reference to the drawings. Same reference signs in the drawings represent elements with the same or similar functions. Although various aspects of the embodiments are illustrated in the drawings, the drawings are not necessarily to scale unless expressly pointed out otherwise.

The dedicated word “exemplary” refers to “as an example or an embodiment, or for descriptive purpose”. Any embodiment illustrated herein as being “exemplary” should not be construed as being preferred to or better than another embodiment.

A term “and/or” herein merely describes an association between associated objects, indicating three possible relationships. For example, by G and/or H, it may mean that there may be three cases, namely, existence of but G, existence of both G and H, or existence of but H. In addition, a term “at least one” herein means any one of multiple, or any combination of at least two of the multiple. For example, including at least one of G, H, and R may mean including any one or more elements selected from a set composed of G, H, and R.

Moreover, a great number of details are provided in embodiments below for a better understanding of the present disclosure. A person having ordinary skill in the art may understand that the present disclosure may be implemented without some details. In some embodiments, a method, means, an element, a circuit, etc., that is well-known to a person having ordinary skill in the art may not be elaborated in order to highlight the main point of the present disclosure.

The method for information processing provided by embodiments of the present disclosure may acquire collecting time of collecting a first image frame to be processed. The first image frame may be acquired by an image collecting device, at collecting time which may be time before exposure, time during the exposure, or time when the exposure ends when the image collecting device collects the first image frame. Due to misalignment of two clocks of the image collecting device and an inertial sensor device, there will be a certain time offset between the collecting time of the first image frame and collecting time of collecting inertial sensor information, resulting in mismatching collecting time of the two. When positioning is performed using the first image frame and the inertial sensor information acquired at the collecting time, the positioning information acquired is not accurate enough. Therefore, calibrated time of the first image frame may be acquired by correcting the collecting time of the first image frame according to currently calibrated time offset information for the first image frame. Then, the calibrated time and an inertial state corresponding to the first image frame is further corrected based on inertial sensor information acquired at the calibrated time of the first image frame, the first image frame, multiple second image frames collected before and corresponding inertial sensor information thereto, to acquire accurate current location information. In other words, positioning and time offset correction may be performed at the same time. Current location information may be determined by accumulating collected calibrated image frames and inertial sensor information. Time offset information of an image frame and the corresponding inertial state are determined by inertial sensor information and image frames calibrated before the image frame, and so on, thereby acquiring more accurate time offset information.

In related art, the time offset between the image collecting device and the inertial sensor is usually calibrated by offline calibration, but this method cannot calibrate the time offset in real time. In some related art, although the time offset may be calibrated in real time, there are some limitations. For example, it is not applicable to a scene of non-linear optimization, or an image feature point has to be tracked continuously. The information processing solution provided by embodiments of the present disclosure may not only calibrate the time offset in real time, but also be applicable to a scene of non-linear optimization. In addition, it is also applicable to an image collecting device of any shutter, such as a camera with a rolling shutter. In addition, it poses no requirement on an image feature point tracking mode and the time interval between two image frames under processing. An information processing solution provided by embodiments of the present disclosure is described below.

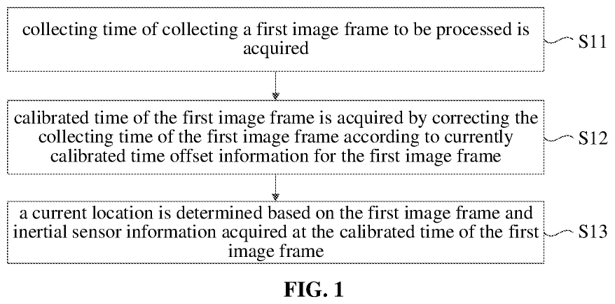

FIG. 1 shows a flowchart of a method for information processing according to an embodiment of the present disclosure. The method for information processing may be executed by terminal equipment, a server, or other information processing equipment. Terminal equipment may be User Equipment (UE), mobile equipment, a user terminal, a terminal, a cell phone, a cordless phone, a Personal Digital Assistant (PDA), handheld equipment, computing equipment, on-board equipment, wearable equipment, etc. In some possible implementations, the method for information processing may be implemented by a processor calling computer-readable instructions stored in memory. The method for information processing in embodiments of the present disclosure is described below by taking information processing equipment as an example.

As shown in FIG. 1, the method includes steps as follows.

In S11, collecting time of collecting a first image frame to be processed is acquired.

In embodiments of the present disclosure, the information processing equipment may acquire the first image frame collected by the image collecting device and the collecting time of the first image frame. The first image frame may be an image frame to be processed waiting for time offset calibration. The collecting time of the first image frame may be the time when the image collecting device collects the first image frame. For example, the collecting time of the first image frame may be time before exposure, time during the exposure, or time when the exposure ends when the image collecting device collects the first image frame.

Here, the image collecting device may be installed on the information processing equipment, and the image collecting device may be a device with a photographing function, such as a webcam, a camera, and the like. The image collecting device may collect an image of a scenery in real time, and transmit a collected image frame to the information processing equipment. The image collecting device may also be set separately from the information processing equipment, and transmit a collected image frame to the information processing equipment through wireless communication. The information processing equipment may be equipment with a positioning function, and there may be multiple positioning modes. For example, the information processing equipment may process an image frame collected by the image collection device, and determine a current location according to the image frame. The information processing equipment may also acquire inertial sensor information detected by inertial sensor equipment, and determine the current location according to the inertial sensor information. The information processing equipment may also combine the image frame and the inertial sensor information, and determine the current location according to the image frame and the inertial sensor information.

In S12, calibrated time of the first image frame is acquired by correcting the collecting time of the first image frame according to currently calibrated time offset information for the first image frame.

In embodiments of the present disclosure, the information processing equipment may acquire the latest time offset information in a storage device, and calibrate the collecting time of the first image frame using the latest time offset information as the currently calibrated time offset information for the first image frame. Time offset information may be a time offset existing between the image collecting device and the inertial sensor device.

In some embodiments of the present disclosure, S12 may include that the calibrated time of the first image frame is acquired by correcting the collecting time of the first image frame according to the currently calibrated time offset information for the first image frame and an exposure duration of the first image frame. As the exposure duration of the first image frame may not be considered when the first image frame is acquired, when the collecting time of the first image frame is calibrated, in order to calibrate the time more accurately, the exposure duration of the first image frame may also be acquired, and the collecting time of the first image frame is corrected combining the currently calibrated time offset information acquired for the first image frame and the exposure duration, acquiring a more accurate calibrated time of the first image frame. Here, the time of the inertial sensor information detected by the inertial sensor device may be used as a reference. When the collecting time of the first image frame is corrected, the collecting time of the first image frame may be converted into the middle time point of the exposure of the first image frame. Combined with the time offset information, the calibrated time of the first image frame may be expressed by the following formula (1):

$${T}_{c} = {t}_{c} + \frac{{t}_{e}}{2} + {t}_{d} ; \qquad ( 1 )$$

T_{c} may represent the calibrated time of the first image frame; t_{c} may represent the collecting time of the first image frame before exposure; t_{c} may represent the exposure duration of the first image frame, and t_{d} may represent the currently calibrated time offset information acquired for the first image frame. The exposure duration may be collected by the image collecting device. For example, when the image collecting device uses a global shutter, or considers inclusion of no impact from the exposure duration, the exposure duration may be 0; when the image collecting device uses a rolling shutter, the exposure duration may be determined according to a row exposure period and a pixel height of an image frame. If the rolling shutter reads one row of pixels at a time, the row exposure period may be the time for the rolling shutter to read one row of pixels at a time.

In S13, a current location is determined based on the first image frame and inertial sensor information acquired at the calibrated time of the first image frame.

In embodiments of the present disclosure, the information processing equipment may acquire the inertial sensor information detected by the inertial sensor device at the calibrated time of the first image frame, and then may combine the acquired inertial sensor information with the collected first image frame, acquiring the location information of the current location. The inertial sensor device here may be a device that detects the motion state of an object, such as an inertial sensor, an angular rate gyroscope, an accelerometer, and the like. The inertial sensor device may detect inertial sensor information such as a 3-axis angular velocity, a 3-axis acceleration of a moving object. The inertial sensor device may be set on the information processing equipment, and connected with the information processing equipment in a wired manner, and transmit the inertial sensor information detected in real time to the information processing equipment. Alternatively, the inertial sensor device may be set separately from the information processing equipment, and transmit the inertial sensor information detected in real time to the information processing equipment through wireless communication.

In some embodiments of the present disclosure, when determining the current location based on the first image frame and the inertial sensor information, the following may be included: determining first relative location information representing a location change relation of an image collecting device based on the first image frame and a second image frame collected before the collecting time of the first image frame; determining second relative location information representing the location change relation of the image collecting device based on the inertial sensor information acquired at the calibrated time of the first image frame and an inertial state corresponding to the second image frame; and determining the current location according to the first relative location information and the second relative location information.

In some embodiments, the location information of a matching feature point as projection of a spatial point in the first image frame and the second image frame may be determined, and the location change relation of the image collecting device in the process that the image collecting device collects the first image frame and the second image frame may be determined according to information on the location of the matching feature point in the first image frame. The location transformation relation may be represented by the first relative location information. Here, an inertial state may be a parameter representing a motion state of an object. The inertial state may include a parameter such as a location, a pose, a velocity, an acceleration bias, an angular velocity bias, etc., and the inertial state corresponding to the second image frame may be the inertia state acquired after time offset compensation (corrected value).

The inertial state corresponding to the second image frame is taken as the initial value for integration, and the inertial sensor information acquired at the calibrated time of the first image frame is integrated, acquiring the estimated inertial state (estimated value) corresponding to the first image frame. From the inertial state (estimated value) corresponding to the first image frame and the inertial state (corrected value) corresponding to the second image frame, the location change relation of the image collecting device in the process that the image collecting device collects the first image frame and the second image frame may be determined. The location transformation relation may be represented by the second relative location information. The inertial state (corrected value) corresponding to the first image frame may be acquired according to the difference between the first relative location information and the second relative location information. The current location may be determined according to the inertial state (corrected value) corresponding to the first image frame.

In some embodiments, the first image frame and the second image frame collected by the image collecting device may be preprocessed, acquiring matching feature points projected in the first image frame and the second image frame; in an implementation, in each image frame, a feature point and/or descriptor may be quickly extracted. For example, a feature point may be a corner point of Features From Accelerated Segment Test (FAST), and a descriptor may be a BRIEF descriptor. After extracting the feature point and/or descriptor, tracking a feature point from the second image frame to the first image frame may be implemented using a sparse optical flow method, and a feature of a frame of a sliding window may be tracked using the descriptor and the feature of the first image frame; Finally, a wrong matching feature point may be removed using an epipolar geometric constraint.

It should be noted that, given limited processing resources of common mobile equipment, each first image frame is not necessarily processed within each time interval to acquire location information, which may reduce the power consumption of the information processing equipment. For example, the processing frequency of processing the first image frame may be set to 10 Hz. The first image frame to be processed is acquired at a frequency of 10 Hz, and positioning is performed based on the first image frame and inertial sensor information. When the first image frame is not processed, inertial sensor information may be used to estimate the current location.

With the method for information processing provided by embodiments of the present disclosure, the collecting time of the first image frame to be processed is corrected. The location preliminarily estimated using the inertial sensor information is corrected by combining the inertial sensor information acquired at the corrected calibrated time and the first image frame, determining accurate location information of the current location, improving positioning accuracy.

In embodiments of the present disclosure, when the collecting time of the first image frame is corrected, the time offset information for the first image frame may be acquired first. The time offset information here may change with the image frame and the inertial sensor information. That is to say, the time offset information is not invariant, and the time offset information may be updated every certain time interval. The offset information is continuously adjusted along with the movement of the information processing equipment, thereby ensuring accuracy of the calibrated time acquired by calibrating the time offset information. The process of determining the currently calibrated time offset information for the first image frame will be described below.

In some embodiments of the present disclosure, when the first image frame is a first image frame collected or a second image frame collected, the currently calibrated time offset information for the first image frame is an initial time offset. Here, the initial value of the time offset or the initial time offset may be set in advance, such as according to the result of offline calibration, or according to the result of online calibration previously used. For example, the initial value of time offset is set to 0.05 s, 0.1 s. If there is no preset initial time offset, the initial time offset may be 0 s. The offline calibration here may be non-real-time time offset calibration, and the online calibration may be real-time time offset calibration.

In some embodiments of the present disclosure, when the first image frame is an Nth image frame collected, the N being a positive integer greater than 2, before acquiring the calibrated time of the first image frame by correcting the collecting time of the first image frame according to the currently calibrated time offset information for the first image frame and an exposure duration of the first image frame, the currently calibrated time offset information for the first image frame may be determined according to at least two second image frames collected before the collecting time of the first image frame.

Here, if the first image frame to be processed is the Nth image frame collected by the image collecting device, the currently calibrated time offset information for the first image frame may be determined based on second image frames collected by the image collecting device before the collecting time of the first image frame. For example, if the first image frame to be processed is the third image frame collected, the time offset information for the first image frame may be determined based on the first image frame collected and the second image frame collected. In this way, the time offset information for the first image frame to be processed may be determined using previously collected second image frames, and the time offset information is continuously adjusted and corrected as the collected image frame changes, thereby ensuring accuracy of the time offset information.

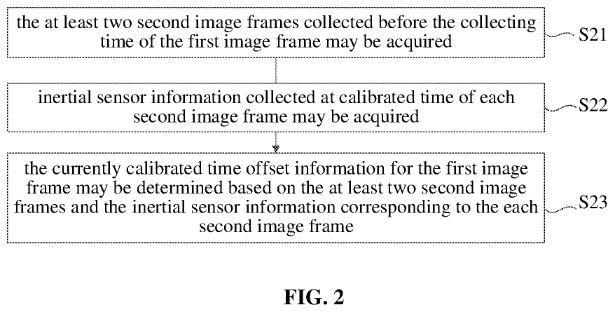

FIG. 2 shows a flowchart of a process of determining time offset information of a first image frame according to an embodiment of the present disclosure.

In S21, the at least two second image frames collected before the collecting time of the first image frame may be acquired.

Here, a second image frame may be an image frame collected by the image collecting device before the collecting time of the first image frame. The information processing equipment may acquire at least two second image frames within a preset time period. The acquired at least two second image frames may respectively have matching feature points for matching image features. In order to ensure the accuracy of the time offset information, the acquired at least two second image frames may be image frames collected close to the collecting time of the first image frame. For example, a fixed time interval may be used as a determining period of determining time offset information. When determining the time offset information for the first image frame to be processed, at least two second image frames collected within the determined period closest to the collecting time of the first image frame may be acquired.

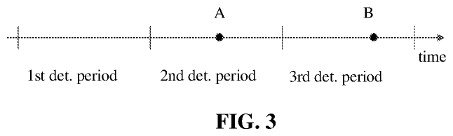

FIG. 3 shows a block diagram of acquiring a second image frame according to an embodiment of the present disclosure. As shown in FIG. 3, at least two second image frames may be acquired at regular intervals. If the collecting time of the first image frame is at point A, the second image frame may be an image frame collected within the first determining period. If the collecting time of the first image frame is at point B, the second image frame may be an image frame collected within the second determining period. Here, in order to ensure the processing speed of the algorithm, the number of second image frames acquired in each time interval may be fixed. After the number of second image frames exceeds a number threshold, a second image frame collected first may be deleted, or a second image frame last collected may be deleted. In order to ensure as little loss of information of the second image frame as possible, the feature point and the inertial state corresponding to a deleted second image frame may be marginalized, that is, a priori information may be formed based on the inertial state corresponding to the deleted second image frame, and participate in optimizing a computing parameter used during positioning.

In some embodiments, a computing parameter used during positioning may be optimized by nonlinear optimization. Nonlinear optimization mainly is: computing inertial measurement energy, visual measurement energy, time offset energy, and a priori energy generated by last marginalization (if it is the first optimization, the a priori energy may be set a priori as needed), and then iteratively solving any state variable to be optimized to acquire the latest state variable. The item of visual measurement energy contains a time parameter to be calibrated; An overall state variable of nonlinear optimization in a sliding window is S=[X₀, X₁, Xₙ, P₀, P₁, . . . Pₖ, t_{d}tᵣ]. When i takes 1 to n, the state variable of the inertial sensor device Xᵢ[=P, q, V, Bₐ, B_{g}]. The n is an integer greater than 1. The P is the location of the inertial sensor device. The q is the pose of the inertial sensor device. The V is the velocity of the inertial sensor device. The Ba is the acceleration bias of the inertial sensor device. The Bg is the gyroscope bias of the inertial sensor device; when j is 0 to k, Pj is a visual feature, which may be parameterized as a 3D location in a global coordinate system or an inverse depth of an initial observation visual frame. The k is an integer greater than or equal to 1; t_{d} is the time offset between the image collecting device and the inertial sensor device. The tᵣ may represent a row exposure time of a rolling shutter camera. Here, if the image collecting device is a global shutter, tᵣ is equal to zero. If the row exposure time of the rolling shutter camera may be directly read, tᵣ may be the row exposure time read. Otherwise, tᵣ may be used as a variable in the formula.

In S22, inertial sensor information collected at calibrated time of each second image frame of the at least two second image frames may be acquired.

The inertial sensor information may be measured by the inertial sensor device according to the motion of the information processing equipment. In order to ensure the accuracy and observability of the time offset information, multiple second image frames and the inertial sensor information corresponding to the second image frames may be used. That is, consider not only the second image frames collected before the first image frame, but also inertial sensor information acquired before the first image frame. The inertial sensor information may be the inertial sensor information acquired by the inertial sensor device at the calibrated time of each second image frame. The calibrated time of a second image frame may be acquired by correcting the collecting time of the second image frame according to the time offset information for the second image frame (or combined with the exposure duration). The process of determining the calibrated time of a second image frame is the same as the process of determining the calibrated time of the first image frame, which will not be repeated here.

Here, the inertial sensor device may include an accelerometer and a gyroscope, and the inertial sensor information may include a 3-axis acceleration and a 3-axis angular velocity. By integrating the acceleration and the angular velocity, information such as a rotation angle, a speed of the current motion state may be acquired.

In S23, the currently calibrated time offset information for the first image frame may be determined based on the at least two second image frames and the inertial sensor information corresponding to the each second image frame.

Here, after acquiring the at least two second image frames and the inertial sensor information, the second image frames and the inertial sensor information may be combined to determine the time offset information for the first image frame. For example, relative location information representing a location change relation in an image collecting process may be determined according to the at least two second image frames. Relative location information representing a location change relation in an image collecting process may be determined according to acquired inertial sensor information. Then, the time offset information between the image collecting device and the inertial sensor device may be acquired according to the difference between the two pieces of relative location information. In addition, an inertial state corresponding to collecting each second image frame after time offset compensation may be acquired. The location of the information processing equipment when collecting each second image frame may be determined using the inertial state corresponding to collecting each second image frame after time offset compensation.

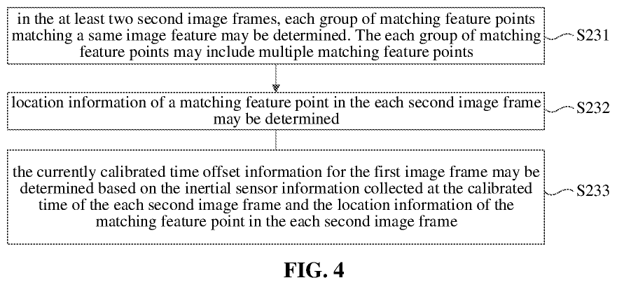

FIG. 4 shows a flowchart of determining time offset information based on a second image frame and inertial sensor information according to an embodiment of the present disclosure. As shown in FIG. 4, the S23 may include steps as follows.

In S231, in the at least two second image frames, each group of matching feature points matching a same image feature may be determined. The each group of matching feature points may include multiple matching feature points.

Here, the information processing equipment may extract feature points in each second image frame. For each second image frame, an image feature of a feature point in the second image frame is matched to an image feature of a feature point in another second image frame to determine, in multiple second image frames, each group of matching feature points matching a same image feature. Each group of matching feature points may include multiple matching feature points respectively from the multiple second image frames. There may be multiple groups of matching feature points matching the same image feature.

For example, suppose that two second image frames are acquired, namely an image frame A and an image frame B. Feature points extracted from the image frame A are a, b, and c. Feature points extracted from the image frame B are d, e and f. Accordingly, image features of feature points a, b, and c may be matched to image features of feature points d, e, and f. If the image feature of the feature point a matches the image feature of the feature point e, then the feature points a and e may form a group of matching feature points, and the feature point a and the feature point e are matching feature points, respectively.

In S232, location information of a matching feature point in the each second image frame may be determined.

Here, location information of a matching feature point may be the image location of the matching feature point in the second image frame. For each group of matching feature points, the location information of the matching feature point in each second image frame may be determined. For example, the location information may be the row and the column corresponding to the pixel point where the matching feature point is located, such as in the example, the row and the column where the feature point a is located in the image frame A, and the row and the column where the feature point e is located in the image frame B.

In S233, the currently calibrated time offset information for the first image frame may be determined based on the inertial sensor information collected at the calibrated time of the each second image frame and the location information of the matching feature point in the each second image frame.

Here, a second image frame may be an image frame collected close to the collecting time of the first image frame. According to the inertial sensor information acquired at the calibrated time of the second image frame, the preliminary estimated inertial state corresponding to the second image frame may be determined. Combining the determined preliminary estimated inertial state corresponding to the second image frame with the location information of a matching feature point in the second image frame, the currently calibrated time offset information for the first image frame may be determined. The inertial state corresponding to the second image frame may be construed as the inertial state of the information processing equipment at the calibrated time of the second image frame. An inertial state may include a parameter such as a location, a pose, and a velocity. When determining the preliminary estimated inertial state corresponding to the second image frame, the inertial state of the information processing equipment determined after time offset compensation in the fixed period before the fixed period in which the second image frame is located may be acquired. Taking the compensated inertial state as the initial value, integration processing is performed on the inertial sensor information acquired at the calibrated time of the second image frame, acquiring the inertial state corresponding to the second image frame preliminarily estimated using the inertial sensor information. Here, the inertial state may be a parameter such as a location, a pose, a velocity, an acceleration bias, an angular velocity bias, etc.

When determining time offset information calibrated for the first image frame, taking two second image frames as an example, according to the location information of matching feature points in the second image frames, the change in the relative location of the information processing equipment within the time interval may be determined. The change in the relative location of the information processing equipment within the time interval may be determined according to the preliminary estimated inertial state within the time interval. Then, according to the difference between the two changes in the relative location, the time offset information between the image collecting device and the inertial sensor device, as well as the corresponding more accurate inertial states corresponding to the second image frames after the time offset compensation, may be acquired.

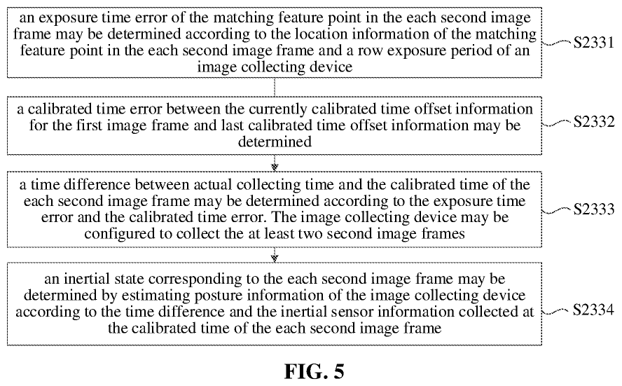

FIG. 5 shows a flowchart of determining an inertial state corresponding to each second image frame near the calibrated time according to an embodiment of the present disclosure. As shown in FIG. 5, in a possible implementation, the S233 may include steps as follows.

In S2331, an exposure time error of the matching feature point in the each second image frame may be determined according to the location information of the matching feature point in the each second image frame and a row exposure period of an image collecting device.

In S2332, a calibrated time error between the currently calibrated time offset information for the first image frame and last calibrated time offset information may be determined.

In S2333, a time difference between actual collecting time and the calibrated time of the each second image frame may be determined according to the exposure time error and the calibrated time error. The image collecting device may be configured to collect the at least two second image frames.

In S2334, an inertial state corresponding to the each second image frame may be determined by estimating posture information of the image collecting device according to the time difference and the inertial sensor information collected at the calibrated time of the each second image frame.

In this possible implementation, with a certain time offset, the calibrated time of a second image frame has a time difference with the actual collecting time of the second image frame. Accordingly, the time difference between the actual collecting time and the calibrated time of a second image frame may be determined using the time of the inertial sensor information as a reference. Then, the posture information of the image collecting device may be estimated using the time difference combined with the inertial sensor information of a second image frame, determining the posture information in an inertial state corresponding to each second image frame.

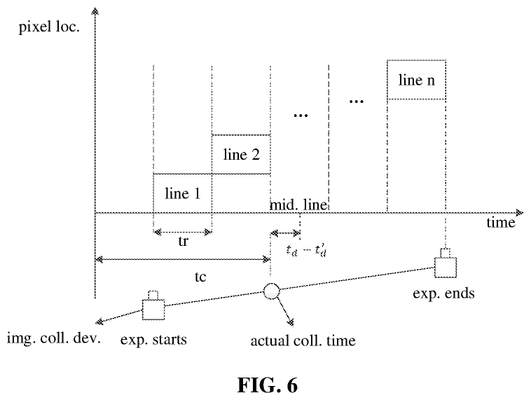

FIG. 6 shows a block diagram of a time shift of an inertial sensor device and an image collecting device according to an embodiment of the present disclosure. The steps S2331 to S2334 will be described below with reference to FIG. 6. Taking the image collecting device being a rolling shutter camera as an example, due to errors in the exposure time and calibrated time of the image collecting device, there is a time difference between the actual collecting time of a second image frame and the calibrated time of the second image frame. Taking the time of the inertial sensor device as a reference, the time difference between the actual collecting time and the calibrated time of a second image frame may be expressed by formula (2):

$$d t = {t}_{d} - {t}_{d}^{′} + ( r - \frac{h}{2} ) * {t}_{r} ; \qquad ( 2 )$$

The dt may represent the time difference. t_{d}−t′_{d} may represent a calibrated time error between the currently calibrated time offset information and the last calibrated time offset information. t_{d} may represent the currently calibrated time offset information. t′_{d} may represent the last calibrated time offset information. The last calibrated time offset information may be the time offset information acquired by a determining period before the determining period of the current calibrated time.

$$( r - \frac{h}{2} ) * {t}_{r}$$

may represent the exposure time error of the matching feature point in the second image frame. r may represent the row number of the pixel in the second image frame where the matching feature point is located. h may represent the pixel height of the second image frame, that is, the total number of rows. The exposure time error is for correcting a time error caused by the exposure time of each row of pixels in the second image frame. A person having ordinary skill in the art may set a mode of computing the exposure time error flexibly according to the type of the image collecting device or as needed for correction.

Using a uniform speed model, it may be assumed that the image collecting device moves at a uniform speed within the time difference. Then, the location of the image collecting device acquired from a certain matching feature point i in the second image frame may be expressed by formula (3):

Pᵢ(t+dt)=P′ᵢ(t)+dt*V′ᵢ (3);

Pᵢ may represent the location of the image collecting device estimated at time t+dt. P′ᵢ may represent the location of the image collecting device at time t. Here, the time t may be the calibrated time after calibration. V′ᵢ is the estimated speed in the inertial state. i may represent the i-th matching feature point, and is a positive integer.

The pose of the image collecting device acquired from a certain matching feature point i in the second image frame is expressed by formula (4):

qᵢ=q′ᵢ⊗q′{wᵢ*dt} (4);

qᵢ may represent the estimated pose of the image collecting device at time t+dt. q′ᵢ may represent the pose of the image collection device at the actual collecting time t. q′{wᵢ*dt} may represent the change in the pose of the image collection device within dt. q′, q′ᵢ, and qᵢ may be four elements. wᵢ represents the angular velocity (the measurement value closest to the calibrated time read directly from the gyroscope).

In this way, posture information in an inertial state corresponding to each second image frame at time t+dt after the time offset of dt may be determined by estimating posture information of the image collecting device according to the time difference and the inertial sensor information.

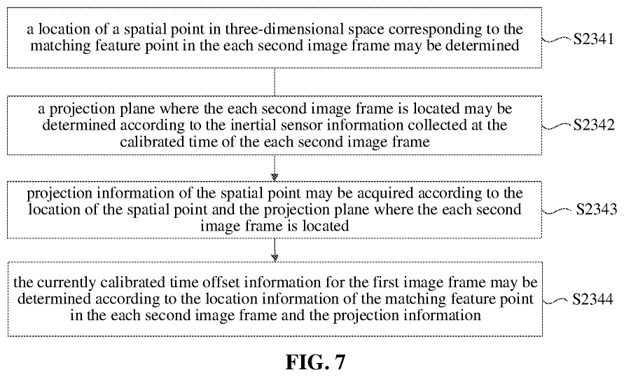

FIG. 7 shows a flowchart of determining time offset information based on location information and an inertial state according to an embodiment of the present disclosure. As shown in FIG. 7, in a possible implementation, the S234 may include steps as follows.

In S2341, a location of a spatial point in three-dimensional space corresponding to the matching feature point in the each second image frame may be determined.

In S2342, a projection plane where the each second image frame is located may be determined according to the inertial sensor information collected at the calibrated time of the each second image frame.

In S2343, projection information of the spatial point may be acquired according to the location of the spatial point and the projection plane where the each second image frame is located.

In S2344, the currently calibrated time offset information for the first image frame may be determined according to the location information of the matching feature point in the each second image frame and the projection information.

In this possible implementation, in the at least two second image frames acquired, there may be matching feature points matching one image feature. Location information of a matching feature point in the at least two second image frames acquired may be an observed value of a spatial point. The following projection energy formula (5) may be established using the matching feature point information observed at least by the two second image frames. If a matching feature point has a location in the three-dimensional space, it may be directly put into the projection energy formula. If a matching feature point does not have a three-dimensional space location, an estimated location in the three-dimensional space may be acquired using the observed location of the matching feature point in a second image frame, and then put into the projection energy formula. The location in the three-dimensional space corresponding to a matching feature point may be based on the three-dimensional location in the world coordinate system, or based on the three-dimensional location expressed by the observed location of the matching feature point in the second image frame by adding an inverse depth. A preliminary estimated inertial state of each second image frame may be acquired using inertial sensor information collected at the calibrated time of the second image frame. The inertial state corresponding to the second image frame after compensation may be determined using the preliminary estimated inertial state of the second image frame. Here, the inertial state corresponding to the second image frame after compensation may be put into the following projection energy formula (5) as a variable. The projection energy formula (5) is as follows:

min_{X,t}_{_{d}}_{,t}_{ᵣ}{Σ_{(i,j,k)∈C}∥e_{C}(Zₖ^{i,j},Xᵢ,Xⱼ,Lₖ,t_{d},tᵣ)∥_{P}_{ⱼ}²} (5);

k may represent the location information of the k-th matching feature point observed in the i-th second image frame and the j-th second image frame. Xᵢ may represent the inertial state corresponding to the i-th second image frame. The projection plane where the i-th second image frame is located may be determined based on the posture information in the inertial state. Xⱼ may represent the inertial state corresponding to the j-th second image frame. The projection plane where the j-th second image frame is located may be determined based on the posture information in the inertial state. The inertial state X may include a variable such as a location, a pose, a velocity, an acceleration bias, an angular velocity bias, etc. Lₖ may represent the location of the three-dimensional space point corresponding to the matching feature point. t_{d} may represent the time offset information between the image collecting device and the inertial sensor device. tᵣ may represent the row exposure period of the image collecting device. Pⱼ may represent the image noise of the j-th matching feature. e_{C} may represent the energy extraction operation, that is, the projection energy. In the energy extraction operation, based on related art, the location of the spatial point and the projection plane may be determined. Moreover, the location information of the matching feature points in the second image frames, as well as the difference between the projection information of projecting the spatial point to at least two projection planes, may be acquired. An energy value may be determined based on the difference. C may represent the energy space formed by i, j, and k. i, j and k may be positive integers. The formula (5) may represent a spatial point in the 3D space. In image frames acquired by the image collecting device photographing the spatial point at different locations, theoretically, the location of the feature point corresponding to the spatial point on an image frame should be the same as the projection location of projecting the spatial point onto the projection plane where the image collecting device at the corresponding location is located. That is, the difference between the two locations may be minimized In other words, the optimized variable (Zₖ^{i,j}, Xᵢ, Xⱼ, Lₖ, t_{d}, tᵣ) acquired through formula (5) minimizes {Σ_{(i,j,k)∈C}∥e_{C}(Zₖ^{i,j}, Xᵢ, Xⱼ, Lₖ, t_{d}, tᵣ)∥_{P}_{ⱼ}²}. Here, there may be multiple matching feature points in each second image frame.

It should be noted that if the row exposure period of the image collecting device may be directly read, the read value may be used as the row exposure period. If the row exposure period is not available, it may be determined by the formula (5) as a variable.

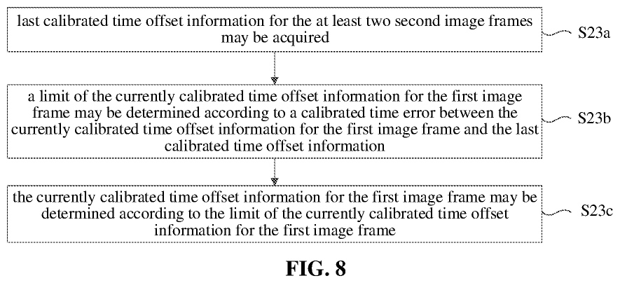

FIG. 8 shows a flowchart of determining time offset information according to an embodiment of the present disclosure. As shown in FIG. 8, steps as follows are included.

In S23a, last calibrated time offset information for the at least two second image frames may be acquired.

In S23b, a limit of the currently calibrated time offset information for the first image frame may be determined according to a calibrated time error between the currently calibrated time offset information for the first image frame and the last calibrated time offset information.

In S23c, the currently calibrated time offset information for the first image frame may be determined according to the limit of the currently calibrated time offset information for the first image frame.

In this implementation, last calibrated time offset information for the at least two second image frames may be acquired. The last calibrated time offset information may be calibrated in the same way as the currently calibrated time offset information, which will not be repeated here. The last calibrated time offset information has been calibrated within a determining period of the last calibrated time offset information and may be read directly. At least two second image frames collected before in one determining period correspond to the same last calibrated time offset information. Then, the difference between the currently calibrated time offset information and the last calibrated time offset information may be taken as the calibrated time error, and the limit of the currently calibrated time offset information may be determined by the calibrated time error. Here, the limit may limit the size of the currently calibrated time offset information. Since the currently calibrated time offset information is unknown, the currently calibrated time offset information may be expressed as a variable, and the limit may be used as a constraint to the currently calibrated time offset information. According to the limit of the currently calibrated time offset information, combined with the formula (5), the currently calibrated time offset information for the first image frame may be determined.

In a possible implementation, while determining the limit of the currently calibrated time offset information for the first image frame according to the calibrated time error between the currently calibrated time offset information for the first image frame and the last calibrated time offset information, the calibrated time error may be compared to a preset time error. When the calibrated time error is less than or equal to the preset time error, it is determined that the limit of the currently calibrated time offset information for the first image frame is zero. When the calibrated time error is greater than the preset time error, the limit of the currently calibrated time offset information for the first image frame is determined according to the calibrated time error and a preset time offset weight. Here, the preset time error may be set according to a specific application scene. For example, the preset time error may be set as the time interval for collecting inertial sensor data, thereby limiting the range of change in the time offset information, ensuring accuracy in time offset information estimation. The formula (6) for the limit of the currently calibrated time offset information is as follows:

$${e}_{t} = \{ \begin{matrix}0 & \vert {t}_{d} - {t}_{d}^{′} \vert \leq {t}_{s} \\ ( {t}_{d} - {t}_{d}^{′} ) * weight & \vert {t}_{d} - {t}_{d}^{′} \vert > {t}_{s}\end{matrix} ; \qquad ( 6 )$$

eₜ may represent the limit of the currently calibrated time offset information. t_{d} may represent the currently calibrated time offset information. t′_{d} may represent the last calibrated time offset information. tₛ may represent the preset time error. weight may represent the time offset weight. The final currently calibrated time offset information t_{d} acquired should make the limit eₜ meet the preset condition, such as minimizing the limit, such as to 0.

In an implementation, the time offset weight may be positively correlated with the calibrated time error. That is, the greater the calibrated time error is, the greater the time offset weight. In this way, the time offset information may be limited to change in a reasonable range, reducing the error and system instability caused by using the uniform speed model. The formula (6) may be used in combination with the formula (5). Reasonable time offset information may be acquired when the value acquired by combining the formula (6) with the formula (5) is the smallest.

The information processing solution provided by embodiments of the present disclosure may calibrate the time offset information of the image collecting device and the inertial sensor device in real time in a non-linear framework. It poses no requirement on the feature point tracking method and the time interval between two consecutive image frames, and is applicable to an image collecting device with any shutter. When the image collecting device is a rolling shutter camera, the row exposure period of the rolling shutter camera may also be calibrated accurately.

An information processing solution provided in embodiments of the present disclosure may be applied to a scene including, but not limited to, augmented reality, virtual reality, robots, autonomous driving, games, film and television, education, e-commerce, tourism, smart medical care, interior decoration design, smart home, smart manufacturing, maintenance and assembly, etc.

It may be understood that method embodiments mentioned in the present disclosure may be combined with each other to form a combined embodiment as long as the combination does not go against a principle or a logic, which is not elaborated in the present disclosure due to a space limitation.

In addition, the present disclosure further provides a device for information processing, electronic equipment, a computer-readable storage medium, and a program, all of which may be configured to implement any method for information processing provided in the present disclosure. Refer to disclosure for a method herein for a technical solution thereof and description therefor, which is not elaborated.

A person having ordinary skill in the art may understand that in a method of a specific implementation, the order in which the steps are put is not necessarily a strict order in which the steps are implemented, and does not form any limitation to the implementation process. A specific order in which the steps are implemented should be determined based on a function and a possible intrinsic logic thereof.

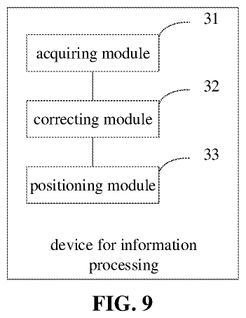

FIG. 9 shows a block diagram of a device for information processing according to an embodiment of the present disclosure. As shown in FIG. 9, the device for information processing includes:

an acquiring module 31 configured to acquire collecting time of collecting a first image frame to be processed;

a correcting module 32 configured to acquire calibrated time of the first image frame by correcting the collecting time of the first image frame according to currently calibrated time offset information for the first image frame; and

a positioning module 33 is configured to determine a current location based on the first image frame and inertial sensor information acquired at the calibrated time of the first image frame.

In some embodiments of the present disclosure, when the first image frame is a first image frame collected or a second image frame collected, the currently calibrated time offset information for the first image frame is an initial time offset.

In some embodiments of the present disclosure, when the first image frame is an Nth image frame collected, and the N is a positive integer greater than 2, the device further includes:

a determining module configured to determine the currently calibrated time offset information for the first image frame according to at least two second image frames collected before the collecting time of the first image frame.

In a possible implementation, the determining module is specifically configured to:

acquire the at least two second image frames collected before the collecting time of the first image frame;

acquire inertial sensor information collected at calibrated time of each second image frame of the at least two second image frames; and

determine the currently calibrated time offset information for the first image frame based on the at least two second image frames and the inertial sensor information corresponding to the each second image frame.

In some embodiments of the present disclosure, the determining module is specifically configured to:

determine, in the at least two second image frames, each group of matching feature points matching a same image feature, wherein the each group of matching feature points comprises multiple matching feature points;

determine location information of a matching feature point in the each second image frame; and

determine the currently calibrated time offset information for the first image frame based on the inertial sensor information collected at the calibrated time of the each second image frame and the location information of the matching feature point in the each second image frame.

In some embodiments of the present disclosure, the determining module is specifically configured to:

determine a location of a spatial point in three-dimensional space corresponding to the matching feature point in the each second image frame;

determine a projection plane where the each second image frame is located according to the inertial sensor information collected at the calibrated time of the each second image frame;

acquire projection information of the spatial point according to the location of the spatial point and the projection plane where the each second image frame is located; and

determine the currently calibrated time offset information for the first image frame according to the location information of the matching feature point in the each second image frame and the projection information.

In some embodiments of the present disclosure, the determining module is further configured to:

determine an exposure time error of the matching feature point in the each second image frame according to the location information of the matching feature point in the each second image frame and a row exposure period of an image collecting device;

determine a calibrated time error between the currently calibrated time offset information for the first image frame and last calibrated time offset information;

determine a time difference between actual collecting time and the calibrated time of the each second image frame according to the exposure time error and the calibrated time error, wherein the image collecting device is configured to collect the at least two second image frames; and

determine an inertial state corresponding to the each second image frame by estimating posture information of the image collecting device according to the time difference and the inertial sensor information collected at the calibrated time of the each second image frame.

In some embodiments of the present disclosure, the determining module is specifically configured to:

acquire last calibrated time offset information for the at least two second image frames;

determine a limit of the currently calibrated time offset information for the first image frame according to a calibrated time error between the currently calibrated time offset information for the first image frame and the last calibrated time offset information; and

determine the currently calibrated time offset information for the first image frame according to the limit of the currently calibrated time offset information for the first image frame.

In a possible implementation, the determining module is specifically configured to:

in response to the calibrated time error being less than or equal to a preset time error, determine that the limit of the currently calibrated time offset information for the first image frame is zero; and

in response to the calibrated time error being greater than the preset time error, determine the limit of the currently calibrated time offset information for the first image frame according to the calibrated time error and a preset time offset weight.

In some embodiments of the present disclosure, the positioning module 33 is specifically configured to:

determine first relative location information representing a location change relation of an image collecting device based on the first image frame and a second image frame collected before the collecting time of the first image frame;

determine second relative location information representing the location change relation of the image collecting device based on the inertial sensor information acquired at the calibrated time of the first image frame and an inertial state corresponding to the second image frame; and

determine the current location according to the first relative location information and the second relative location information.

In some embodiments of the present disclosure, the correcting module 32 is specifically configured to:

acquire the calibrated time of the first image frame by correcting the collecting time of the first image frame according to the currently calibrated time offset information for the first image frame and an exposure duration of the first image frame.

In some embodiments, a function or a module of a device provided in embodiments of the present disclosure may be configured to implement a method described in a method embodiment herein. Refer to description of a method embodiment herein for specific implementation of the device, which is not repeated here for brevity.

Embodiments of the present disclosure also propose a computer-readable storage medium having stored thereon a computer program which, when executed by a processor, implements a method herein. A computer-readable storage medium may be a non-volatile computer-readable storage medium.

Correspondingly, embodiments of the present disclosure also propose a computer program, including a computer-readable code which, when run in electronic equipment, allow a processor in the electronic equipment to implement any method for information processing herein.

Embodiments of the present disclosure also propose electronic equipment, including: a processor; and a memory configured to store processor-executable instructions. The processor is configured to implement a method herein.

Electronic equipment may be provided as a terminal, a server or equipment in another form.

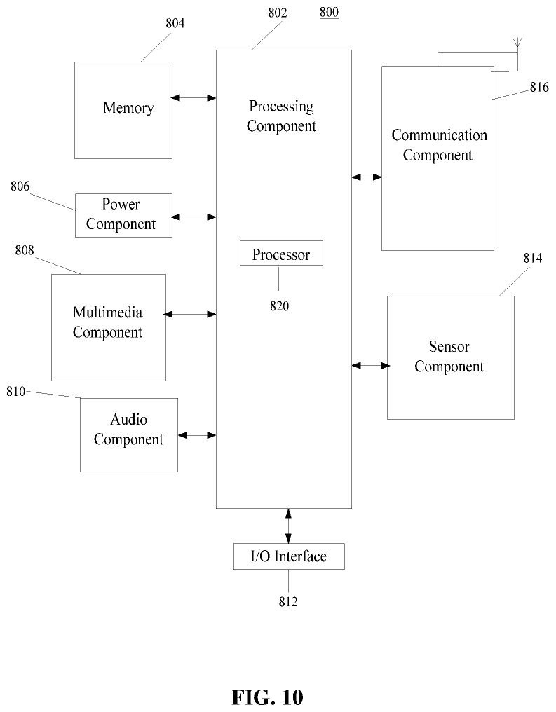

FIG. 10 is a block diagram of electronic equipment 800 according to an exemplary embodiment. For example, the electronic equipment 800 may be a terminal such as a mobile phone, a computer, a digital broadcasting terminal, messaging equipment, a game console, tablet equipment, medical equipment, fitness equipment, a Personal Digital Assistant (PDA), etc.

Referring to FIG. 10, the electronic equipment 800 may include one or more components as follows: a processing component 802, memory 804, a power component 806, a multimedia component 808, an audio component 810, an Input/Output (I/O) interface 812, a sensor component 814, and a communication component 816.

The processing component 802 generally controls an overall operation of the electronic equipment 800, such as operations associated with display, a telephone call, data communication, a camera operation, a recording operation, etc. The processing component 802 may include at least one processor 820 to execute instructions so as to complete all or some options of the method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operation on equipment 1700. Example of such data may include instructions of any application or method configured to operate on the electronic equipment 800, contact data, phonebook data, messages, pictures, videos, and/or the like. The memory 804 may be realized by any type of volatile or non-volatile storage equipment or combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk, or compact disk.

The power component 806 supplies electric power to various components of the electronic equipment 800. The power component 806 may include a power management system, one or more power supplies, and other components related to generating, managing and distributing electric power for the electronic equipment 800.

The multimedia component 808 includes a screen providing an output interface between the electronic equipment 800 and a user. in some embodiments, the screen may include a Liquid Crystal Display (LCD) and a Touch Panel (TP). If the screen includes a TP, the screen may be realized as a touch screen to receive an input signal from a user. The TP includes one or more touch sensors for sensing touch, slide and gestures on the TP. The touch sensors not only may sense the boundary of a touch or slide move, but also detect the duration and pressure related to the touch or slide move. In some embodiments, the multimedia component 808 includes a front camera and/or a rear camera. When the equipment 1700 is in an operation mode such as a shooting mode or a video mode, the front camera and/or the rear camera may receive external multimedia data. Each of the front camera and the rear camera may be a fixed optical lens system or may have a focal length and be capable of optical zooming.

The audio component 810 is configured to output and/or input an audio signal. For example, the audio component 810 includes a microphone (MIC). When the electronic equipment 800 is in an operation mode such as a call mode, a recording mode, and a voice recognition mode, the MIC is configured to receive an external audio signal. The received audio signal may be further stored in the memory 804 or may be sent via the communication component 816. In some embodiments, the audio component 810 further includes a loudspeaker configured to output the audio signal.

The I/O interface 812 provides an interface between the processing component 802 and a peripheral interface module. Such a peripheral interface module may be a keypad, a click wheel, a button or the like. Such a button may include but is not limited to: a homepage button, a volume button, a start button, and a lock button.

The sensor component 814 includes one or more sensors for assessing various states of the electronic equipment 800. For example, the sensor component 814 may detect an on/off state of the equipment 1700 and relative positioning of components such as the display and the keypad of the electronic equipment 800. The sensor component 814 may further detect a change in the position of the electronic equipment 800 or of a component of the electronic equipment 800, whether there is contact between the electronic equipment 800 and a user, the orientation or acceleration/deceleration of the electronic equipment 800, and a change in the temperature of the electronic equipment 800. The sensor component 814 may include a proximity sensor configured to detect existence of a nearby object without physical contact. The sensor component 814 may further include an optical sensor such as a Complementary Metal-Oxide-Semiconductor (CMOS) or Charge-Coupled-Device (CCD) image sensor used in an imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless/radio communication between the electronic equipment 800 and other equipment. The electronic equipment 800 may access a radio network based on a communication standard such as WiFi, 2G, 3G, . . . , or a combination thereof. The communication component 816 receives a broadcast signal or broadcasts related information from an external broadcast management system via a broadcast channel. In an exemplary embodiment, the communication component 816 further includes a Near Field Communication (NFC) module for short-range communication. For example, the NFC module may be realized based on Radio Frequency Identification (RFID), Infrared Data Association (IrDA), Ultra-WideBand (UWB) technology, BlueTooth (BT) technology, and other technologies.

The electronic equipment 800 may be realized by one or more of Application Specific Integrated Circuits (ASIC), Digital Signal Processors (DSP), Digital Signal Processing Device (DSPD), Programmable Logic Devices (PLD), Field Programmable Gate Arrays (FPGA), controllers, microcontrollers, microprocessors or other electronic components, to implement the method.

In an exemplary embodiment, there is also provided a non-volatile computer-readable storage medium, such as the memory 804 including computer program instructions. The computer program instructions may be executed by the processor 820 of the electronic equipment 800 to implement a method herein.

The present disclosure may be a system, a method, and/or a computer program product. The computer program product may include a computer-readable storage medium, having borne thereon computer-readable program instructions allowing a processor to implement various aspects of the present disclosure.

A computer-readable storage medium may be tangible equipment capable of keeping and storing an instruction used by instruction executing equipment. For example, a computer-readable storage medium may be, but is not limited to, electric storage equipment, magnetic storage equipment, optical storage equipment, electromagnetic storage equipment, semiconductor storage equipment, or any appropriate combination thereof. A non-exhaustive list of more specific examples of a computer-readable storage medium may include a portable computer disk, a hard disk, Random Access Memory (RAM), Read-Only Memory (ROM), Erasable Programmable Read-Only Memory (EPROM, or flash memory), Static Random Access Memory (SRAM), Compact Disc Read-Only Memory (CD-ROM), a Digital Video Disc (DVD), a memory stick, a floppy disk, mechanical coding equipment such as a protruding structure in a groove or a punch card having stored thereon an instruction, as well as any appropriate combination thereof. A computer-readable storage medium used here may not be construed as a transient signal per se, such as a radio wave, another freely propagated electromagnetic wave, an electromagnetic wave propagated through a wave guide or another transmission medium (such as an optical pulse propagated through an optical fiber cable), or an electric signal transmitted through a wire.

A computer-readable program instruction described here may be downloaded from a computer-readable storage medium to respective computing/processing equipment, or to an external computer or external storage equipment through a network such as the Internet, a Local Area Network (LAN), a Wide Area Network (WAN), and/or a wireless network. A network may include a copper transmission cable, optical fiber transmission, wireless transmission, a router, a firewall, a switch, a gateway computer, and/or an edge server. A network adapter card or a network interface in respective computing/processing equipment receives the computer-readable program instruction from the network, and forwards the computer-readable program instruction to computer-readable storage media in respective computing/processing equipment.

A computer program instruction for implementing an operation herein may be an assembly instruction, an Instruction Set Architecture (ISA) instruction, a machine instruction, a machine related instruction, a microcode, a firmware instruction, state setting data, or a source code or object code written in any combination of one or more programming languages. A programming language includes an object-oriented programming language such as Smalltalk, C++, etc., as well as a conventional procedural programming language such as C or a similar programming language. Computer-readable program instructions may be executed on a computer of a user entirely or in part, as a separate software package, partly on the computer of the user and partly on a remote computer, or entirely on a remote computer/server. When a remote computer is involved, the remote computer may be connected to the computer of a user through any type of network including a Local Area Network (LAN) or a Wide Area Network (WAN). Alternatively, the remote computer may be connected to an external computer (such as connected through the Internet using an Internet service provider). In some embodiments, an electronic circuit such as a programmable logic circuit, a Field-Programmable Gate Array (FPGA), or a Programmable Logic Array (PLA) is customized using state information of a computer-readable program instruction. The electronic circuit may execute the computer-readable program instruction, thereby implementing various aspects of the present disclosure.

Aspects of the present disclosure have been described with reference to flowcharts and/or block diagrams of the method, device (system), and computer program product of embodiments of the present disclosure. It is be understood that each block in the flowcharts and/or the block diagrams and a combination of respective blocks in the flowcharts and/or the block diagrams may be implemented by computer-readable program instructions.

These computer-readable program instructions may be provided to a general-purpose computer, a dedicated computer, or a processor of another programmable data processing device, thereby producing a machine to allow the instruction to produce, when executed through a computer or the processor of another programmable data processing device, a device implementing a function/move specified in one or more blocks in the flowcharts and/or the block diagrams. The computer-readable program instructions may also be stored in a computer-readable storage medium. The instructions allow a computer, a programmable data processing device and/or other equipment to work in a specific mode. Accordingly, the computer-readable medium including the instructions includes a manufactured article including instructions for implementing each aspect of a function/move specified in one or more blocks in the flowcharts and/or the block diagrams.

Computer-readable program instructions may also be loaded to a computer, another programmable data processing device, or other equipment, such that a series of operations are executed in the computer, the other programmable data processing device, or the other equipment to produce a computer implemented process, thereby allowing the instructions executed on the computer, the other programmable data processing device, or the other equipment to implement a function/move specified in one or more blocks in the flowcharts and/or the block diagrams.

The flowcharts and block diagrams in the drawings show possible implementation of architectures, functions, and operations of the system, method, and computer program product according to multiple embodiments of the present disclosure. In this regard, each block in the flowcharts or the block diagrams may represent part of a module, a program segment, or an instruction. The part of the module, the program segment, or the instruction includes one or more executable instructions for implementing a specified logical function. In some alternative implementations, functions noted in the blocks may also occur in an order different from that noted in the drawings. For example, two consecutive blocks may actually be implemented basically in parallel. They sometimes may also be implemented in a reverse order, depending on the functions involved. Also note that each block in the block diagrams and/or the flowcharts, as well as a combination of the blocks in the block diagrams and/or the flowcharts, may be implemented by a hardware-based application-specific system for implementing a specified function or move, or by a combination of an application-specific hardware and a computer instruction.

Description of embodiments of the present disclosure is exemplary, not exhaustive, and not limited to the embodiments disclosed herein. Various modification and variations can be made without departing from the principle of embodiments of the present disclosure. The modification and variations will be apparent to a person having ordinary skill in the art. Choice of a term used herein is intended to best explain the principle and/or application of the embodiments, or improvement to technology in the market, or allow a person having ordinary skill in the art to understand the embodiments disclosed herein.

### INDUSTRIAL APPLICABILITY

Embodiments of the present disclosure propose a method for information processing, electronic equipment, and a storage medium. The method includes: acquiring collecting time of collecting a first image frame to be processed; acquiring calibrated time of the first image frame by correcting the collecting time of the first image frame according to currently calibrated time offset information for the first image frame; and determining a current location based on the first image frame and inertial sensor information acquired at the calibrated time of the first image frame. In embodiments of the present disclosure, collecting time of collecting a first image frame to be processed may be acquired; then, calibrated time of the first image frame may be acquired by correcting the collecting time of the first image frame according to currently calibrated time offset information for the first image frame. Given impact of a reason such as an error, there will be a certain time offset in the collecting time of the first image frame. Accordingly, the collecting time of the first image frame may be corrected to acquire a more accurate calibrated time. Then, a current location is determined in real time using the inertial sensor information acquired at the calibrated time and the first image frame, improving positioning accuracy.

1. A method for information processing, comprising:
acquiring collecting time of collecting a first image frame to be processed;
acquiring calibrated time of the first image frame by correcting the collecting time of the first image frame according to currently calibrated time offset information for the first image frame; and
determining a current location based on the first image frame and inertial sensor information acquired at the calibrated time of the first image frame.

2. The method of claim 1, wherein in response to the first image frame being a first image frame collected or a second image frame collected, the currently calibrated time offset information for the first image frame is an initial time offset.

3. The method of claim 1, further comprising: in response to the first image frame being an Nth image frame collected, the N being a positive integer greater than 2,
determining the currently calibrated time offset information for the first image frame according to at least two second image frames collected before the collecting time of the first image frame.

4. The method of claim 3, wherein determining the currently calibrated time offset information for the first image frame according to the at least two second image frames collected before the collecting time of the first image frame comprises:
acquiring the at least two second image frames collected before the collecting time of the first image frame;
acquiring inertial sensor information collected at calibrated time of each second image frame of the at least two second image frames; and
determining the currently calibrated time offset information for the first image frame based on the at least two second image frames and the inertial sensor information corresponding to the each second image frame.

5. The method of claim 4, wherein determining the currently calibrated time offset information for the first image frame based on the at least two second image frames and the inertial sensor information corresponding to the each second image frame comprises:
determining, in the at least two second image frames, each group of matching feature points matching a same image feature, wherein the each group of matching feature points comprises multiple matching feature points;
determining location information of a matching feature point in the each second image frame; and
determining the currently calibrated time offset information for the first image frame based on the inertial sensor information collected at the calibrated time of the each second image frame and the location information of the matching feature point in the each second image frame.

6. The method of claim 5, wherein determining the currently calibrated time offset information for the first image frame based on the inertial sensor information collected at the calibrated time of the each second image frame and the location information of the matching feature point in the each second image frame comprises:
determining a location of a spatial point in three-dimensional space corresponding to the matching feature point in the each second image frame;
determining a projection plane where the each second image frame is located according to the inertial sensor information collected at the calibrated time of the each second image frame;
acquiring projection information of the spatial point according to the location of the spatial point and the projection plane where the each second image frame is located; and
determining the currently calibrated time offset information for the first image frame according to the location information of the matching feature point in the each second image frame and the projection information.

7. The method of claim 5, further comprising:
determining an exposure time error of the matching feature point in the each second image frame according to the location information of the matching feature point in the each second image frame and a row exposure period of an image collecting device;
determining a calibrated time error between the currently calibrated time offset information for the first image frame and last calibrated time offset information;
determining a time difference between actual collecting time and the calibrated time of the each second image frame according to the exposure time error and the calibrated time error, wherein the image collecting device is configured to collect the at least two second image frames; and
determining an inertial state corresponding to the each second image frame by estimating posture information of the image collecting device according to the time difference and the inertial sensor information collected at the calibrated time of the each second image frame.

8. The method of claim 3, wherein determining the currently calibrated time offset information for the first image frame according to the at least two second image frames collected before the collecting time of the first image frame comprises:
acquiring last calibrated time offset information for the at least two second image frames;
determining a limit of the currently calibrated time offset information for the first image frame according to a calibrated time error between the currently calibrated time offset information for the first image frame and the last calibrated time offset information; and
determining the currently calibrated time offset information for the first image frame according to the limit of the currently calibrated time offset information for the first image frame.

9. The method of claim 8, wherein determining the limit of the currently calibrated time offset information for the first image frame according to the calibrated time error between the currently calibrated time offset information for the first image frame and the last calibrated time offset information comprises:
in response to the calibrated time error being less than or equal to a preset time error, determining that the limit of the currently calibrated time offset information for the first image frame is zero; and
in response to the calibrated time error being greater than the preset time error, determining the limit of the currently calibrated time offset information for the first image frame according to the calibrated time error and a preset time offset weight.

10. The method of claim 1, wherein determining the current location based on the first image frame and the inertial sensor information acquired at the calibrated time of the first image frame comprises:
determining first relative location information representing a location change relation of an image collecting device based on the first image frame and a second image frame collected before the collecting time of the first image frame;
determining second relative location information representing the location change relation of the image collecting device based on the inertial sensor information acquired at the calibrated time of the first image frame and an inertial state corresponding to the second image frame; and
determining the current location according to the first relative location information and the second relative location information.

11. The method of claim 1, wherein acquiring the calibrated time of the first image frame by correcting the collecting time of the first image frame according to the currently calibrated time offset information for the first image frame comprises:
acquiring the calibrated time of the first image frame by correcting the collecting time of the first image frame according to the currently calibrated time offset information for the first image frame and an exposure duration of the first image frame.

12. Electronic equipment, comprising:
a processor; and
a memory configured to store processor-executable instructions,
wherein the processor is configured to implement:
acquiring collecting time of collecting a first image frame to be processed;
acquiring calibrated time of the first image frame by correcting the collecting time of the first image frame according to currently calibrated time offset information for the first image frame; and
determining a current location based on the first image frame and inertial sensor information acquired at the calibrated time of the first image frame.

13. The electronic equipment of claim 12, wherein in response to the first image frame being a first image frame collected or a second image frame collected, the currently calibrated time offset information for the first image frame is an initial time offset.

14. The electronic equipment of claim 12, wherein the processor is configured to implement: in response to the first image frame being an Nth image frame collected, the N being a positive integer greater than 2,
determining the currently calibrated time offset information for the first image frame according to at least two second image frames collected before the collecting time of the first image frame.

15. The electronic equipment of claim 14, wherein the processor is configured to determine the currently calibrated time offset information for the first image frame according to the at least two second image frames collected before the collecting time of the first image frame, by:
acquiring the at least two second image frames collected before the collecting time of the first image frame;
acquiring inertial sensor information collected at calibrated time of each second image frame of the at least two second image frames; and
determining the currently calibrated time offset information for the first image frame based on the at least two second image frames and the inertial sensor information corresponding to the each second image frame.

16. The electronic equipment of claim 15, wherein the processor is configured to determine the currently calibrated time offset information for the first image frame based on the at least two second image frames and the inertial sensor information corresponding to the each second image frame, by:
determining, in the at least two second image frames, each group of matching feature points matching a same image feature, wherein the each group of matching feature points comprises multiple matching feature points;
determining location information of a matching feature point in the each second image frame; and
determining the currently calibrated time offset information for the first image frame based on the inertial sensor information collected at the calibrated time of the each second image frame and the location information of the matching feature point in the each second image frame.

17. The electronic equipment of claim 14, wherein the processor is configured to determine the currently calibrated time offset information for the first image frame according to the at least two second image frames collected before the collecting time of the first image frame, by:
acquiring last calibrated time offset information for the at least two second image frames;
determining a limit of the currently calibrated time offset information for the first image frame according to a calibrated time error between the currently calibrated time offset information for the first image frame and the last calibrated time offset information; and
determining the currently calibrated time offset information for the first image frame according to the limit of the currently calibrated time offset information for the first image frame.

18. The electronic equipment of claim 12, wherein the processor is configured to determine the current location based on the first image frame and the inertial sensor information acquired at the calibrated time of the first image frame, by:
determining first relative location information representing a location change relation of an image collecting device based on the first image frame and a second image frame collected before the collecting time of the first image frame;
determining second relative location information representing the location change relation of the image collecting device based on the inertial sensor information acquired at the calibrated time of the first image frame and an inertial state corresponding to the second image frame; and
determining the current location according to the first relative location information and the second relative location information.

19. The electronic equipment of claim 12, wherein the processor is configured to acquire the calibrated time of the first image frame by correcting the collecting time of the first image frame according to the currently calibrated time offset information for the first image frame, by:
acquiring the calibrated time of the first image frame by correcting the collecting time of the first image frame according to the currently calibrated time offset information for the first image frame and an exposure duration of the first image frame.

20. A non-transitory computer-readable storage medium having stored thereon computer program instructions which, when executed by a processor, implement:
acquiring collecting time of collecting a first image frame to be processed;
acquiring calibrated time of the first image frame by correcting the collecting time of the first image frame according to currently calibrated time offset information for the first image frame; and
determining a current location based on the first image frame and inertial sensor information acquired at the calibrated time of the first image frame.
